(19) United States
(12) Patent Application Publication
(10) Pub. No.: US 2009/0101222 A1
(43) Pub. Date: Apr. 23, 2009

(54) Pressure accumulator, especially pulsation damper

(76) Inventors: Herbert Baltes, Losheim (DE); Markus Lehnert, Dillingen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/584,713

(22) PCT Filed: Jan. 18, 2005
(86) PCT No.: PCT/EP2005/000410

§ 371 Date: Jun. 26, 2006

(30) Foreign Application Priority Data
Jan. 29, 2004 (DE) 10 2004 004 341.8

(51) Int. Cl. F15B 1/10

(52) U.S. Cl. 138/30; 138/31

(57) ABSTRACT

The invention relates to a pressure accumulator, especially a pulsation damper, which comprises an accumulator housing (10) and a piston element (28) disposed therein. A bellows-type separative element (30) is supported on the piston part (28) with its one end (32) and with its other end (34) on the accumulator housing (10). Said separative element (30) separates two working chambers (26, 40) within the accumulator housing (10) from each other, especially a gas chamber (26) from a fluid chamber (40), in a fluid-tight, especially gas-tight manner. The one working chamber (26), in addition to a defined volumetric proportion of a working gas, is filled with a fluid. In this manner the working gas allows for a compression to a certain degree and thus for a dampening and smoothening of the pulsations of the fluid medium migrating to and occurring on the fluid side of the accumulator.

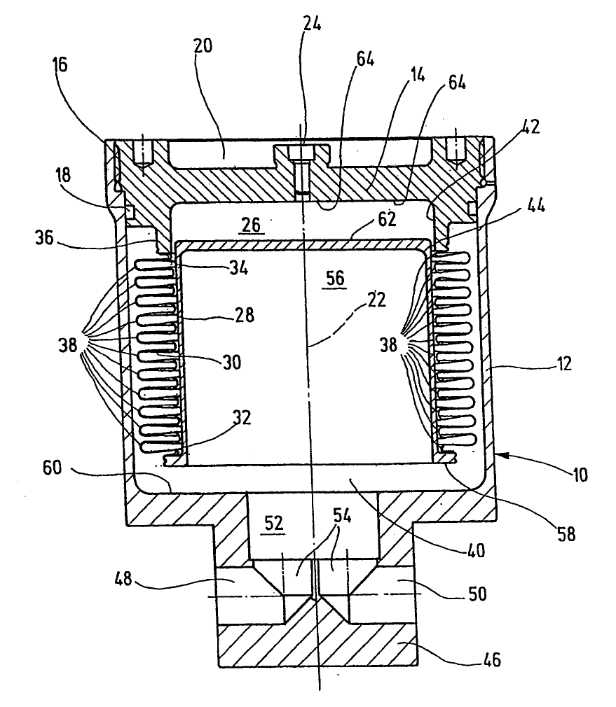

The invention relates to a pressure accumulator, especially a pulsation damper having a pressure accumulator housing and a piston part located therein, a bellows-like separating element being supported with its one end on the piston part and with its other end on the pressure accumulator housing, and the separating element separating two working chambers from each other, especially a gas space from a fluid space within the pressure accumulator housing, in a fluid-tight, especially gastight, manner.

In the prior art (WO 01/55602 A1) so-called hydropneumatic pressure accumulators are known, with a bellows which separates a gas space from an oil space within the pressure accumulator housing, especially in the form of a metal bellows which is attached on its one end to the pressure accumulator housing, such that the oil space borders the inside of the bellows which on its other free end is sealed by a closure body which can be moved according to volume changes of the gas space and oil space as the two working chambers of the pressure accumulator, and with a valve which blocks or releases the flow of the hydraulic fluid out of and into the oil space, and which in the movement of a closure body which corresponds to an increase in the volume of the gas space which exceeds a given maximum value, by which the closure body can be transferred into its blocking position, the closure body being made in the form of a trough with a bottom designed as a movable valve member of the valve which controls the flow of the hydraulic fluid medium.

As is recognized, in bellows-type pressure accumulators with rubber bellows or metal bellows, care must be taken that overloading of the bellows be avoided. In another known pressure accumulator (WO 97/46823 A1), with respect to this problem a valve stem of the valve connected to the oil space is configured relative to the closure body of the metal bellows in a positional relationship such that the closure body of the metal bellows made as a flat end plate acts on the valve stem when a desired end position is reached and moves it into the blocking position of the valve, so that the outflow of the hydraulic fluid from the oil space is stopped when this end position of the end plate of the metal bellows is reached. With the valve closed, thus even when the connected hydraulic system should become unpressurized, a pressure is maintained in the oil space of the pressure accumulator which corresponds to the gas pressure prevailing at the time in the gas space so that a pressure equilibrium prevails on the metal bellows on either side.

This prevents overloading of the bellows when in operation of the pressure accumulator the pressure of the hydraulic system connected on the oil side decreases, but there is furthermore the danger of damage to the bellows in states with an overpressure prevailing on the oil side or in the absence of the prefill pressure on the gas side. Since in the known pressure accumulator of the aforementioned type the maximum value of the volume of the gas space corresponds essentially to the stroke volume which is defined by the motion of the end plate which takes place when the metal bellows contracts and expands, the stroke length which the end plate can traverse within the pressure accumulator housing must be selected to be relatively long if a gas space volume sufficient for pressure accumulator operation is to be made available. In the absence of a gas prefill pressure or overpressure prevailing on the oil side, therefore the prevailing pressure gradient acts on the fully extended and thus mechanically most heavily loaded metal bellows. It is therefore necessary to use either thicker or multilayer metal bellows. Disadvantageously for this reason the spring stiffness is greatly increased; this leads to a comparatively poor response behavior in operation. Multilayer bellows lead to increased weight and higher costs. Moreover the stroke per turn of the bellows is less.

In the initially mentioned solution according to WO 01/55602 A1, in addition there is a valve stem which is attached to the trough bottom and which extends concentrically to the longitudinal axis out of the pressure accumulator housing and is connected to a second movable valve element which, when the motion of the trough exceeds a given minimum value of the volume of the gas space, interacts with a second valve seat which blocks the flow of the hydraulic fluid into the oil space, so that the advantageous possibility arises of controlling the end position of the trough which corresponds to the minimum value of the volume of the gas space using an oil-side valve. Since in the known solution the entire interior of the trough is available as part of the gas space, in this respect an optimum ratio is achieved between the total size of the pressure accumulator housing and the volume of the gas space, although the volume to be assigned to the gas space for accommodation and management, especially in the form of pulsation damping for the hydraulic fluid as a further fluid, cannot then be available. In the known solution, the pressure accumulator housing can be shaped such that it forms a mechanical stop after short stroke motion of the trough, because the entire interior of the trough is available as a gas space volume, and in this respect the metal bellows as a whole is protected not only against overly strong expansion, but since it surrounds the outside of the indicated trough, the bellows at the overpressure prevailing in the gas space is also mechanically supported on the outside of the trough over the entire length. In spite of this circumstance and in spite of the existing very small “dead volume” between the trough and bellows, it however cannot be precluded in this respect that individual folds of the metal bellows are still unduly exposed to stresses and in this way can tear and fail. Furthermore, both in the area of the valve element and also in the area of the possible trigger point between the trough which can move lengthwise and the inside wall of the pressure accumulator housing, seals are necessary which are fundamentally subject to wear and consequently can lead to failure of the known hydropneumatic pressure accumulator solution.

On the basis of this prior art, the object of this invention is to further improve known pressure accumulator solutions while maintaining their advantages, such that in a very small installation space a large measure of damping is achieved with respect to the pulsations of a hydraulic fluid including fuel such as diesel fuel as another fluid in the fluid space of the pressure accumulator, with simultaneous implementation of effective protection for each individual fold or deflection of the bellows in order to ensure reliable operation even over very long cycle times with a plurality of changing load cycles. This object is achieved by a pressure accumulator with the features of claim 1 in its entirety.

In that, as specified in the characterizing part of claim 1 one working chamber is filled with a fluid besides a definable volumetric portion of a working gas, up to a definable degree the working gas allows compression, and in this way damping and smoothing of the pulsations of the pertinent fluid medium which occur on the fluid side of the pressure accumulator.

By adding a fluid to the side of one working chamber of the pressure accumulator with the working gas, the gas space formed in this way is reduced accordingly in volume by the fluid filling, and decoupling from the working gas to the fluid can take place such that the fluid as a damping support medium enters between the folds and deflections of the bellows-like separating element on its inside, so that in the expansion and contraction processes of the bellows in operation of the pressure accumulator, the pertinent folded wall parts of the bellows can be supported on the fluid as an opposing support; this leads to a detectable increase of the service life of the pressure accumulator a claimed in the invention and consequently to an increase in its operating reliability. The latter applies especially for rapid pulsations and high-speed pressure surges. Depending on the position of the piston part assumed at the time and the position of the bellows-like connecting element which is connected in this respect, the fluid can be displaced with the other working gas into the working chamber or can be recovered from there back into the intermediate spaces between the folds for support processes.

Preferably a fluid is used which can flow very quickly as a thin-liquid medium within the working chamber with the working gas, and furthermore the fluid must be suitable in the area of the design temperature for the pressure accumulator to perform its intended task, for example from −10° C. to +160° C. Furthermore, it has proven advantageous to use a fluid charge with which it is ensured that little working gas within the fluid goes into solution in order in this way to not unnecessarily reduce the effective volumetric portion of working gas for damping of pressure surges. A combination of nitrogen gas as the working gas and ethylene alcohol as the fluid on the gas side of the pressure accumulator as a fluid charge has proven especially advantageous. Preferably the volumetric portions of the working gas and fluid are chosen to be the same or there is preferably slightly more fluid than working gas in the indicated working chamber of the pressure accumulator. In different exemplary embodiments, it is also possible to choose the spaces and/or charging amounts differently in terms of their magnitude. Advantageously however it must be watched that the gas space is essentially filled with fluid shortly before the maximum spring path has been reached.

Another advantage in this solution is that the piston side on the actual fluid side of the pressure accumulator can be provided with a cavity which can be filled with additional fluid, so that in this way, on the fluid side of the pressure accumulator, the accommodation capacity for the hydraulic fluid including fuels is increased in order to improve the effectiveness of the pressure accumulator for pulsation damping, in this way a different approach being taken compared to the known solutions in which the attempt is made to improve the working capacity of the pressure accumulator such that the intended cavity of the piston part has been placed on the side of the working chamber with the working gas (cf. WO 01/55602 A1). It is surprising to one with average skill in the art in the area of pressure accumulators that by reversing this action principle with a reduced gas proportion with simultaneous filling with a fluid on the gas side of the pressure accumulator improved damping values for the fluid penetrating into the pressure accumulator occur, attaining increased operating reliability at the same time. Since the pertinent pressure accumulator solution for the movable parts manages without additional seals, in this regard the prerequisite for continuous operation free of wear is also present.

Other advantageous embodiments of the pressure accumulator as claimed in the invention are the subject matter of the other dependent claims.

The invention will now be detailed below using one exemplary embodiment shown in the drawings, in which a metal bellows is used.

The single FIGURE shows a longitudinal section of the indicated exemplary embodiment of the pressure accumulator.

The illustrated exemplary embodiment of a pressure accumulator is intended especially for use in fuel and heavy oil systems in order to damp and smooth pressure surges of the pertinent operating medium. In the area of fuels, especially diesel fuel or the like is meant. Furthermore, the pertinent pressure accumulator could also be used in electrohydraulic braking systems, for example in vehicle construction. The illustrated pressure accumulator has a pressure accumulator housing designated as a whole as 10, with an essentially circularly cylindrical, pot-like main part 12. The main part 12, viewed in the direction of looking at the FIGURE, at the top has a cover part 14 which can be connected to the pot-like main part 12 via a threaded section 16, and the interior of the pressure accumulator housing 10 is sealed against the environment by way of a sealing means in the form of a gasket 18. For reasons of weight reduction, the cover part 14 can be provided with a material recess 20, and along the longitudinal axis 22 of the pressure accumulator the cover part 14 is penetrated by a sealing screw 24, after removal of which the working gas, for example in the form of nitrogen gas and/or a fluid, for example in the form of ethylene glycol, are allowed to flow by way of a suitable device (not shown) into the working chamber 26 of the pressure accumulator which is conventionally also referred to only as the gas space in conventional pressure accumulators.

A piston part 28 which is present within the pressure accumulator housing 10 is configured to be able to move axially along the longitudinal axis 22 of the pressure accumulator. Furthermore, a bellows-like separating element 30 extends along the outer peripheral side of the piston part 28 and is supported with its one end 32 on the piston part 28 and with its other end 34 on an annular extension 36 of the cover part 14 which projects down. The separating element 30 is preferably designed as a metal bellows, with a plurality of annular individual folds 38 or deflections which extend over the cylindrical piston part 28 on the outer peripheral side with a definable distance in a zig-zag shape in the form of pleats. Furthermore the piston part 28 also separates, in a fluid-tight manner, one working chamber 26 which is also referred to as the gas space 26 from another, second working chamber 40 which is also referred to as the fluid space in these pressure accumulators.

The annular extension 36 of the cover part 14 which in this respect should be regarded as a component of the pressure accumulator housing 10, on its inside has a cylindrical guide surface 42 within which the top end of the piston part 28 is guided to be able to move lengthwise, while maintaining a radial distance in the form of an annular gap 44. Furthermore, the pressure accumulator housing 10, viewed in the direction of looking at the FIGURE, on its bottom has a cylindrical pipe union 46, with two fluid connections 48, 50 which discharge into a common antechamber 52 within the pipe union 46. Here the two fluid connections 48, 50 at a right angle to the longitudinal axis 22 of the pressure accumulator enter the pipe union 46 and emerge from it, and for purposes of optimized flow guidance it has proven effective if fluid guidance is undertaken in this way by deflection points 54 which run at a right angle thereto perpendicular to the respective alignment of the fluid connection 48, 50. It is sufficient for operation of the pressure accumulator if there is fluid over the antechamber 52 in the other working chamber 40, and fluid passage is not absolutely necessary and even with the fluid column stationary pulsations and pressure surges which occur can be accordingly smoothed and damped. Furthermore, it is advantageous if the fluid connections 48, 50 in the pipe union 46 enter and exit at the same height and discharge jointly over this same path into the antechamber 52, due to the identically acting deflection points 54.

To increase the volume of the fluid space on the side of the other working chamber 40 of the pressure accumulator the piston part 28 has a cylindrical cavity 56 which except for a reduced wall thickness for the piston part 28 essentially fills it. In the area of the connection between the bellows-like separating element 30 to the piston part 28 on its one end 32 the piston part 28 has an annularly widening stop 58 for striking the assigned adjacent inside wall 60 of the pressure accumulator housing 10 into which the antechamber 52 of the pipe union 46 discharges. The piston part 28 is furthermore on its end opposite the stop 58 provided with a stop surface 62 running transversely to the longitudinal axis 22 of the pressure accumulator which is used to strike the other, opposite inside wall 64 of the pressure accumulator housing 10, preferably formed by the cover part 14. With stop surfaces formed in this way, a type of overload protection is ensured which helps prevent squeezing together or overwidening which damages the metal bellows by pulling apart.

By way of the aforementioned annular gap 44, it is possible that partial fluid filling occurs in the working chamber 26 between the formed cavities between the individual folds 38 and the outer periphery of the piston part 28, in order in this way in the movements of the individual folds 33 to support them accordingly, in a compression process in which two adjacent walls of an individual fold 38 move toward each other that the fluid accommodated in this way is forced back in the direction of the working chamber 26; this is for example the case when, viewed in the direction of looking at the FIGURE, from the pertinent initial state of the piston part 28 it travels up in the direction of the inside wall 64, and for the opposite motion of the piston part 28 and when the folds 38 are pulled apart, the corresponding fluid volume can flow after from the working chamber 46 via the annular gap 44 into the intermediate spaces between the folds 38, if the pertinent intermediate spaces are connected to the annular gap 44 and the working chamber 26 to carry fluid.

Essentially this working chamber 26 is filled with a working gas, for example, nitrogen gas, which in this respect for purposes of smoothing or damping accommodates pressure surges which are delivered on the fluid side 40 of the pressure accumulator into the latter. Possible heating in the area of the metal bellows as a bellows-like separating element 30 can be likewise easily managed with the fluid delivered in the working chamber 26, especially in the form of ethylene glycol, which otherwise as a thin liquid medium has good inflow and outflow behavior and furthermore dissolves little working gas, this being necessary for the damping behavior of the pressure accumulator. Use for rubber bellows as a bellows-like separating element 30 is likewise meant.

1. Pressure accumulator, especially a pulsation damper with a pressure accumulator housing (10) and a piston part (28) located therein, a bellows-like separating element (30) being supported with its one end (32) on the piston part (28) and with its other end (34) on the pressure accumulator housing (10), and the separating element (30) separating two working chambers (26, 40) from each other, especially a gas space (26) from a fluid space (40) within the pressure accumulator housing (10), in a fluid-tight, especially gastight, manner, characterized in that
one working chamber (26) is filled with a fluid, besides a definable volumetric portion of a working gas.

2. The pressure accumulator as claimed in claim 1, wherein the fluid with which one working chamber (26) with the working gas is filled, is an alcohol, preferably ethylene glycol.

3. The pressure accumulator as claimed in claim 2, wherein the other working chamber (40) is provided with fluid connections (48, 50) by way of which another fluid, especially in the form of diesel fuel or heavy oil, can be delivered into the interior of the pressure accumulator housing (10).

4. The pressure accumulator as claimed in claim 3, wherein the piston part (28) on its side facing the other working chamber (40) has a cavity (56) which is intended for holding the additional fluid.

5. The pressure accumulator as claimed in claim 1, wherein the piston part (28) at least over part of its possible path is movably guided along parts (42) of the pressure accumulator housing (10), preferably in its cover part (14), with a definable radial distance.

6. The pressure accumulator as claimed in claim 3, wherein the piston part (28) on its side facing the fluid connection (48, 50) is provided with a stop (58) for striking the inside wall (60) of the pressure accumulator housing (10).

7. The pressure accumulator as claimed in claim 6, wherein the piston part (28) on its end opposite the stop (58) is provided with a stop surface (62) for striking another inside wall (64) of the pressure accumulator housing (10), preferably formed by the cover part (14).

8. The pressure accumulator as claimed in claim 1, wherein the bellows-like separating element (30) consists of a metal bellows, with a plurality of individual folds (38) located on top of one another.

9. The pressure accumulator as claimed in claim 3, wherein the fluid connections (48, 50) run within the pipe union (46) of the pressure accumulator housing (10) and within this pipe union (46) discharge into its common antechamber (52).

10. The pressure accumulator as claimed in claim 5, wherein the piston part (28), at least along one part of its possible path, borders an annular gap (44) which forms the radial distance and via which the working gas with one fluid travels to the inside of the bellows-like separating element (30).
